(19) United States
(12) Patent Application Publication
(10) Pub. No.: US 2006/0274161 A1
(43) Pub. Date: Dec. 7, 2006

(54) Method and apparatus to determine ambient light using a camera

(75) Inventors: Stephen Ing, Beaverton, OR (US); Manoj Agnihotri, Lake Oswego, OR (US); Paul Diefenbaugh, Portland, OR (US)

Correspondence Address: INTEL CORPORATION, P.O. BOX 5326, SANTA CLARA, CA, 95056-5326, US

(73) Assignee: Intel Corporation

(21) Appl. No.: 11/144,539

(22) Filed: Jun. 3, 2005

(51) Int. Cl. H04N 5/235

(52) U.S. Cl. 348/229.1

(57) ABSTRACT

A system includes a camera that may be used for multiple applications including an application to measure the ambient light. The camera may include an automatically set a gain or an aperture as well as a shutter speed. The shutter speed and the gain or aperture from the camera may be used to determine the ambient light. Brightness of a display may be adjusted based on the ambient light.

### FIELD OF INVENTION

The present invention relates generally to the field of power management; and, more specifically, to a technique for measuring ambient light.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems typically include one or more processors. A processor may manipulate and control the flow of data in a computer. To provide more powerful computer systems for consumers, processor designers strive to continually increase the operating speed of the processor. Unfortunately, as processor speed increases, the power consumed by the processor tends to increase as well.

One approach to reducing overall power consumption of a computer system is to change the focus of power reduction from the processor to other components that have a significant impact on power. For example, display screens of computer systems typically consume a significant amount of power. For many backlit liquid crystal display (LCD) screens, increasing the brightness of the display screen typically increases its power consumption, and decreasing the brightness of the display screen typically decreases its power consumption. Therefore, it is typically in a user's best interest to operate the display screen at a low brightness level, while still providing comfortable viewing, to reduce power consumption.

To accomplish this, the user would typically need to manually readjust the brightness of the display screen each time ambient lighting conditions change. For today's mobile systems, ambient lighting conditions may change regularly, placing undue burden on the user to continually readjust the display screen brightness. Unless these adjustments are made, however, battery life will suffer. The present invention addresses this and other problems associated with the prior art.

### BRIEF DESCRIPTION OF THE DRAWINGS

The present invention is illustrated by way of example and not limitation in the accompanying figures in which like references indicate similar elements and in which:

FIG. 1 is a block diagram illustrating an example of a computer system that may be used, in accordance with an embodiment.

FIG. 2A is a diagram illustrating an example of a computer system having a camera that may be used for many applications, in accordance with one embodiment.

FIG. 2B is a diagram illustrating an example of a configuration that is used to measure ambient light, in accordance with one embodiment.

FIG. 3 is a plot of the data shown in Table 1, in accordance with one embodiment.

FIG. 4 is a plot of the data shown in Table 1 after the vertical axis is modified to a logarithmic scale, in accordance with one embodiment

FIG. 5 is a plot of the ambient light data shown in Table 2, in accordance with one embodiment.

FIG. 6 is a flow diagram illustrating one example of a process that may be used to determine the ambient light, in accordance with one embodiment.

### DETAILED DESCRIPTION

In some embodiments, a computer system may include an image capturing device. The image capturing device may be used for various applications. One application is to measure ambient light which may be determined based on shutter speed and gain of the image capturing device.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Computer System

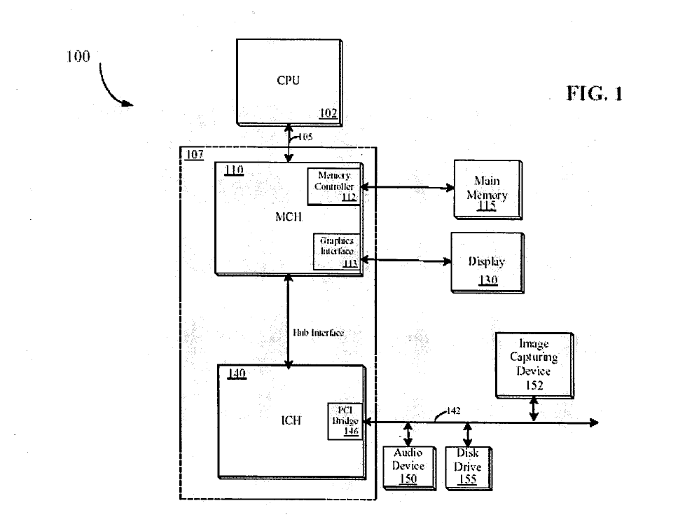

FIG. 1 is a block diagram illustrating an example of a computer system that may be used, in accordance with an embodiment. Computer system 100 may include a central processing unit (CPU) 102 and may receive its power from an electrical outlet or a battery (not shown). The CPU 102 and chipset 107 may be coupled to bus 105.

The chipset 107 may include a memory control hub (MCH) 110. The MCH 110 may include a memory controller 112 that is coupled to memory 115. The memory 115 may store data and sequences of instructions that are executed by the CPU 102 or any other processing devices included in the computer system 100. The data may include time dependent or isochronous data that needs to be processed or delivered within certain time constraints. For example, multimedia streams require an isochronous transport mechanism to ensure that data is delivered as fast as it is displayed and to ensure that the audio is synchronized with the video. The data may include asynchronous data which may be delivered in random intervals, and synchronous data which may be delivered only at specific intervals.

The MCH 110 may include a graphics interface 113. Display 130 may be coupled to the graphics interface 113. The chipset 107 may also include an input/output control hub (ICH) 140. The ICH 140 is coupled with the MCH 110 via a hub interface. The ICH 140 provides an interface to input/output (I/O) devices within the computer system 100. The ICH 140 may include PCI bridge 146 that provides an interface to PCI bus 142. The PCI bridge 146 may provide a data path between the CPU 102 and peripheral devices. An audio device 150, an image capturing device 152, and a disk drive 155 may be connected to the PCI bus 142. The disk drive 155 may include a storage media to store data and sequences of instructions that are executed by the CPU 102 or any other processing devices included in the computer system 100. Although not shown, other devices (e.g., keyboard, mouse, etc.) may also be connected to the PCI bus 142 or other system bus.

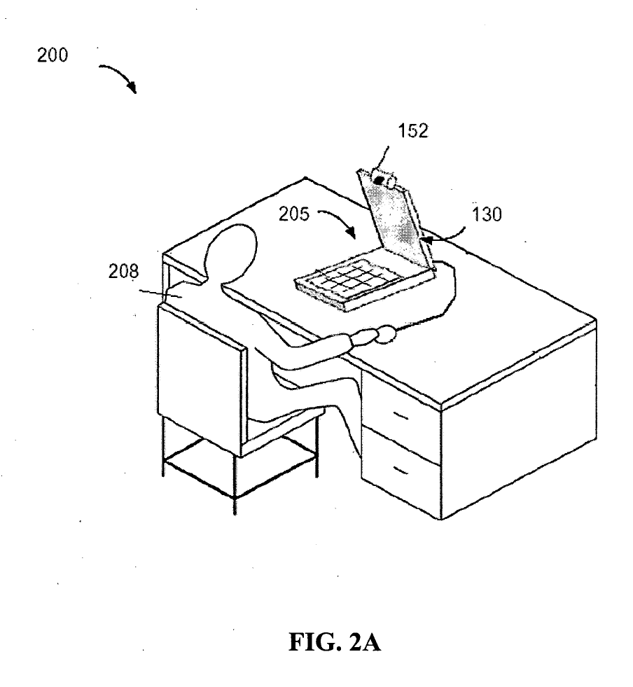

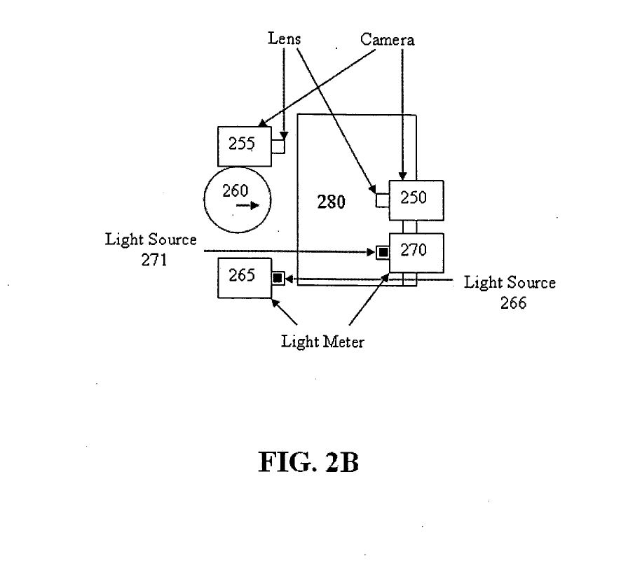

FIG. 2A is a diagram illustrating an example of a computer system having a camera that may be used for many applications, in accordance with one embodiment. In this example, configuration 200 may include an image capturing device 152 and a computer system 205 (e.g., laptop, notebook, etc.). The computer system 205 may include components described in FIG. 1 and may draw power from either an alternating current (AC) power source or from a direct current (DC) power source such as, for example, a battery. The computer system 205 may include a display 130. Although the image capturing device 152 is shown attached to the display 130, it may be detachable from the display 130 and repositioned at another place (e.g., next to the display 225). For one embodiment, the image-capturing device 152 may be positioned to capture an image of an area in front of the computer system 205. The image-capturing device 152 may be used for various applications such as, for example, still photo capturing, video recording, video teleconferencing, etc. One application is measuring ambient light. Typically, a user 208 is positioned near or in front of the computer system 205. Depending on the operating platform of the computer system 230 (e.g., Windows, etc), a device driver (not shown) may be used to enable the image-capturing device 152 to interact with the computer system 205.

Ambient Light

Ambient light may include light on the scene or the light near or within vicinity of the user 208 and of the computer system 230. This light may depend on available natural light and artificial light. For example, when there is a bright light source behind the computer system 230 directing at the user 208, the ambient light of the area in front of the user 208 may be high or bright. When the computer system 230 is positioned in a low light area, the ambient light of the area in front of or around the user 208 may be low.

The ambient light may be measured using an ambient light sensor or light meter such as, for example, the Gossen Mavo-Monitor by Gossen Company of Germany. Referring to the example illustrated in FIG. 2A, the ambient light reading by the ambient light meter may be different when measured at different angle relative to the user 208. For example, when the ambient light meter is positioned at an angle in front of or facing the user 208, the ambient light reading may be different from when the ambient light meter is positioned at an angle behind or facing away from the user 208. The ambient light may be used to adjust the brightness of the display 130. For example, when the ambient light is low, the brightness of the display 130 may be reduced. Reducing the brightness of the display may reduce the power consumption associated with the display.

Automatic Exposure Control

Typically, to compensate for the varying light conditions, the image capturing device 152 may include an automatic exposure control feature which may control the aperture and the shutter speed of the image capturing device 152. The shutter speed is the amount of time that a shutter remains open so light is allowed to pass through the aperture. Leaving the shutter open for a longer period of time may allow more light to pass through the aperture. Shutter speed may be measured in seconds, or fractions of seconds. Typical shutter speeds are: 1/2000 second (sec.), 1/1000 sec, 1/500 sec, 1/250 sec, 1/125 sec, 1/60 sec, 1/30 sec, 1/15 sec, ⅛ sec, ¼ sec, ½ sec and 1 second. A fast shutter speed may require a larger aperture to avoid an under-exposed image. A slow shutter speed may require a small aperture to avoid an over-exposed image. As will be described in the following sections, the shutter speed may be used to determine the ambient light.

Aperture

The aperture is associated with the camera lens and is the size of the opening to allow light in. The standard camera terminology for aperture is f-stop. Some examples of f-stops are f1.8, f2.2, . . . , f7.1, f8. The f-stop (or aperture opening) may be fixed or variable. The f-stop numbers may be higher for smaller openings and smaller for larger openings. For example, the f-stop may be set to a large number (for small aperture opening) when there is lots of light. As will be described in the following sections, the aperture opening may be used to determine the ambient light.

Gain

For one embodiment, the image capturing device 152 may be a digital camera (referred to herein as the camera 152), although other image capturing device format may also be used. The automatic exposure control feature of most digital cameras automatically set aperture and shutter speed for optimal exposure. Some automatic exposure control feature may employ a fixed aperture and apply a digital gain factor in its place. This gain factor (or gain) may be determined automatically using a gain control logic (not shown) commonly referred to as automatic gain control (AGC) such as, for example, the AGC of the Logitech QuickCam for Notebook Pro from Logitech Inc. of Fremont, Calif. The AGC may enable the camera 152 to be sensitive to different light condition. As the ambient light falls, the AGC may cause an increase in gain. A large gain factor may be viewed as corresponding to a large aperture opening, and a small gain factor may be viewed as corresponding to a small aperture opening.

Determining Ambient Light Using Shutter Speed and Gain or Aperture

For one embodiment, when the aperture is variable, the number associated with the aperture opening (or aperture number) and the shutter speed may be used to determine the ambient light. For another embodiment, when the aperture number is fixed, and the camera includes the AGC, the gain and the shutter speed may be used to determine the ambient light. As mentioned above, the aperture number, the gain and the shutter speed may be automatically determined by the automatic exposure control of the camera 152 and may be received from the camera 152 via an interface (not shown).

FIG. 2B is a diagram illustrating an example of a configuration that is used to measure ambient light, in accordance with one embodiment. Data collected using this configuration is obtained and shown in the following table (referred to as Table 1). The data includes multiple samples of gain and shutter speed frequency (defined as 1/shutter speed). The configuration includes two cameras 250 and 255 set to point to two different directions relative to a user 260 positioned in front of a computer system 265. The camera 250 faces the user 260, and the camera 255 faces away from the user 260. There are two light meters 265, 270. Each light meter is also associated with a light source 266 and 271, respectively. In this configuration, the Logictech Quickcam cameras and the Marvo-Monitor light meters are used. With each sample, the shutter speed frequency and the gain are collected from the two cameras. Comfortably viewed LCD display brightness data is also illustrated with a high number corresponding to a brighter setting than a low number.

TABLE 1

| | Camera 1 - Facing the User | | | Camera 2 - Facing Away from User | | | |
|---|---|---|---|---|---|---|---|
| | | Shutter Speed | | | Shutter Speed | | |
| Sample | | Frequency | Light Meter | | Frequency | Light Meter | Display |
| Number | Gain | (1/value)(second) | Reading (*) | Gain | (1/value)(second) | Reading (*) | Brightness |
| 0 | 474 | 25 | 70 | 474 | 33 | 150 | 7 |
| 1 | 474 | 33 | 400 | 474 | 50 | 250 | 7 |
| 2 | 474 | 50 | 280 | 474 | 50 | 190 | 7 |
| 3 | 474 | 25 | 150 | 474 | 25 | 30 | 7 |
| 4 | 3792 | 25 | 9 | 5372 | 25 | 26 | 5 |
| 5 | 6162 | 25 | 2 | 7268 | 25 | 7 | 4 |
| 6 | 2844 | 25 | 17 | 2844 | 25 | 18 | 6 |
| 7 | 2054 | 25 | 26 | 474 | 25 | 73 | 7 |
| 8 | 474 | 33 | 570 | 474 | 33 | 120 | 7 |
| 9 | 474 | 33 | 145 | 474 | 50 | 370 | 7 |
| 10 | 474 | 50 | 350 | 474 | 50 | 300 | 7 |
| 11 | 6320 | 25 | 3 | 8216 | 25 | 40 | 5 |
| 12 | 8216 | 25 | 0 | 8216 | 25 | 8 | 2 |
| 13 | 2212 | 25 | 14 | 474 | 33 | 160 | 7 |
| 14 | 474 | 33 | 50 | 474 | 33 | 700 | 7 |
| 15 | 474 | 250 | 700 | 474 | 33 | 100 | 7 |

*The Mavo-Monitor light meter typically provides reading in cd/m² units with a lens.

The readings shown in Table 1 above were taken without using the lens to provide a wider field of vision. Hence, the cd/m² units are not applicable. However, the readings in the table are actual readings read off the light meter. These readings at different ambient light levels are useful regardless of the units.

The data for each sample (row) in Table 1 include readings from four different devices (cameras 250, 255 and light meters 260, 270) positioned as illustrated in the example in FIG. 2B. The camera 255 (and the light meter 260) positioned near the user 260 sees about the same as what the user's eyes see. The camera 250 (and the light meter 270) positioned near the computer system 280 faces the user 260 and sees the scene surrounding the user 260. The readings from the light meters 260 and 270 may help providing a mechanism to confirm the determination of the ambient light using the gain and the shutter speed frequency from the cameras 250 and 255.

It may be noted in the above example that the light meter readings from the light meter 270 facing the user may be different from the light meter readings from the light meter 260 facing away from the user. The data under the shutter speed frequency readings column may be read as 1/value (seconds). The value may be, for example, 1/25 (seconds) or 1 25^{th} of a second.

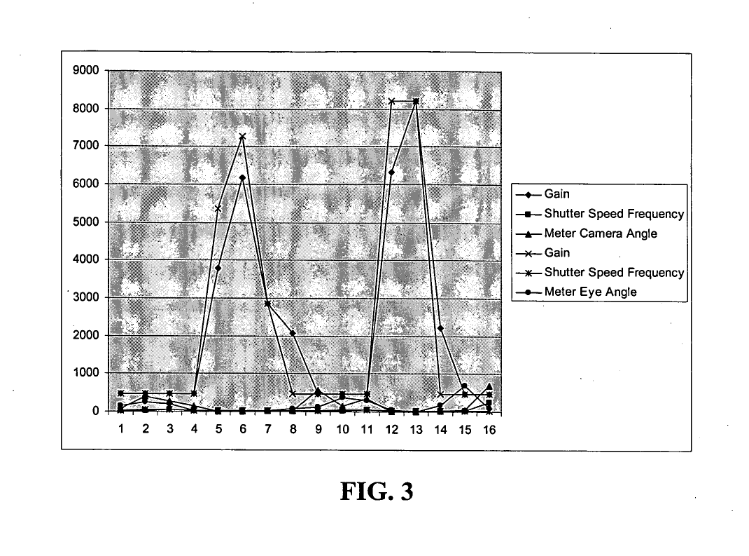

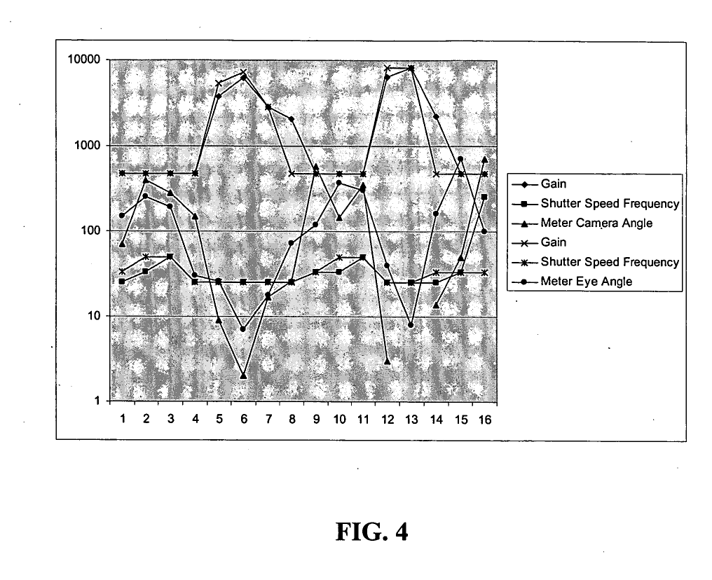

FIG. 3 is a plot of the data shown in Table 1. The horizontal axis indicates the samples, and the vertical axis indicates the readings in the Table 1. The units along the vertical axis are mixed because there are several different sets of data. From this plot, a model of the data may be determined. For one embodiment, the vertical axis may be modified to a logarithmic scale. This results in the data illustrated in the plot in FIG. 4. From the plot in FIG. 4, it may be observed that the gains of the two cameras 250, 255 are close to each other, and the light meter readings from the two light meters 260, 270 are close to each other.

It may be observed that the graphs of the shutter speed of each camera and its corresponding light meter reading move in the same directions. For one embodiment, it can be shown on the logarithmic scale that the application of a scale factor and a linear offset may provide a reasonably good calculation to map the camera settings (gain and shutter speed) to the actual light meter readings. In mathematical terms, the light meter reading may be approximated using the following formula:
Logarithm (Meter Reading)˜=B*Freq+C−log(Gain)
Using the data shown in the Table 1 and plotting the results for various values of B, C, the following values of B and C are derived: B= 1/25, C=3.5. It may be noted that the values of B and C may vary depending on the camera. This mapping of the camera settings may also be applicable when the camera settings include the shutter speed and the aperture opening (instead of the gain). In this situation, the logarithm of the aperture number is used instead of the logarithm of the gain.

The following table (referred to as Table 2) includes multiple pair of values of ambient light determined using the shutter speed frequencies and the gain, and the corresponding light meter readings. The first two columns include readings from the camera and the light meter facing the user, and the second two columns include readings from the camera and the light meter facing away from the user.

TABLE 2

| Camera | Light meter | Camera facing | Light meter facing |
|---|---|---|---|
| facing user | facing user | away from user | away from user |
| 1.824222 | 1.845098 | 2.144222 | 2.176091 |
| 2.144222 | 2.60206 | 2.824222 | 2.39794 |
| 2.824222 | 2.447158 | 2.824222 | 2.278754 |
| 1.824222 | 2.176091 | 1.824222 | 1.477121 |
| 0.921132 | 0.954243 | 0.769864 | 1.414973 |
| 0.710278 | 0.30103 | 0.638585 | 0.845098 |
| 1.04607 | 1.230449 | 1.04607 | 1.255273 |
| 1.1874 | 1.414973 | 1.824222 | 1.863323 |
| 2.144222 | 2.755875 | 2.144222 | 2.079181 |
| 2.144222 | 2.161368 | 2.824222 | 2.568202 |
| 2.824222 | 2.544068 | 2.824222 | 2.477121 |
| 0.699283 | 0.477121 | 0.58534 | 1.60206 |
| 0.58534 | undefined | 0.58534 | 0.90309 |
| 1.155215 | 1.146128 | 2.144222 | 2.20412 |
| 2.144222 | 1.69897 | 2.144222 | 2.845098 |
| 10.82422 | 2.845098 | 2.144222 | 2 |

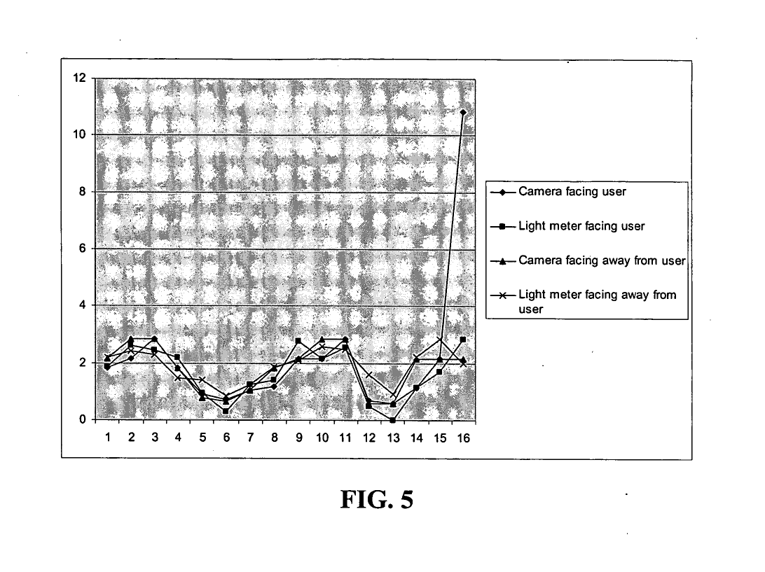

FIG. 5 is a plot of the data in Table 2. As can be observed, the plot includes graphs that are very similar to each other indicating that the determined ambient light (as estimated by the formula above) is closely related to the ambient light as measured by the light meter. It may be noted that the example data shown in Table 2 includes one undefined entry. This is due to the light meter reading of zero in sample number 12 of Table 1. The undefined entry is because log of zero is undefined. The light meter reading of zero may be due to lack of resolution at the low end of the scale. In theory, the number from Table 1 would not have been zero, and hence the value in Table 2 would not have been undefined. If, for example, the reading in Table 1 had been one, which is a small number, the value in Table 2 would have been log(1) which is zero. If the reading was less than one, the value in Table 2 would have been negative.

Process

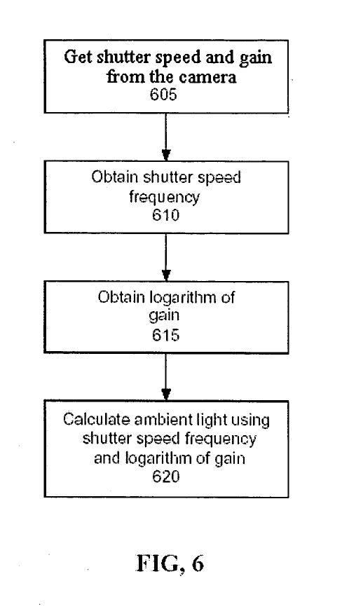

FIG. 6 is a flow diagram illustrating one example of a process that may be used to determine the ambient light, in accordance with one embodiment. At block 605, the shutter speed and the gain are obtained from the camera. At block 610, a logarithm of the gain is determined. At block 615, the shutter speed frequency is determined. At block 620, the shutter speed frequency and the logarithm of the gain are used to determine the ambient light. As discussed above, this process may also be used with by getting an aperture number from the camera when the aperture is variable.

Computer Readable Media

In some embodiments, it is to be understood that they may be implemented as one or more software programs stored within a machine readable medium. A machine readable medium includes any mechanism for storing or transmitting information in a form readable by a machine (e.g., a computer). For example, a machine readable medium includes read only memory (ROM), random access memory (RAM), magnetic disk storage media, optical storage media, flash memory devices, electrical, optical, acoustical or other form of propagated signals (e.g., carrier waves, infrared signals, digital signals, etc.), etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
getting shutter speed and gain of a camera, wherein the shutter speed and the gain are set automatically by the camera; and
determining ambient light using the shutter speed and the gain.

2. The method of claim 1, further comprising adjusting brightness of a display based on the ambient light.

3. The method of claim 2, wherein determining the ambient light using the gain comprises taking a logarithm of the gain.

4. The method of claim 3, wherein determining the ambient light using the shutter speed comprises determining shutter speed frequency using the shutter speed.

5. The method of claim 4, wherein determining the ambient light comprises scaling the shutter speed frequency and applying a linear offset.

6. A system to measure ambient light, comprising:
an image capturing device configured to set a shutter speed and a gain, the image capturing device having an interface to provide the shutter speed and the gain;
logic to determine shutter speed frequency using the shutter speed;
logic to determine logarithm of the gain; and
logic to determine the ambient light using the shutter speed frequency and the logarithm of the gain.

7. The system of claim 6, wherein the image capturing device is coupled to a display, and wherein the ambient light is used to adjust brightness of the display.

8. The system of claim 7, wherein the image capturing device is a digital camera configured with an automatic gain control (AGC) feature to automatically set the gain.

9. The system of claim 8, wherein the image capturing device is configured to set a fixed aperture.

10. A system, comprising:
a processor;
a display coupled to the processor; and
a camera coupled to the display, the camera including an automatic exposure control to set shutter speed, wherein the processor is to determine ambient light using the shutter speed.

11. The system of claim 10, wherein the automatic exposure control is further to set an aperture or a gain, and wherein the processor is to determine the ambient light using the shutter speed and the aperture or the gain.

12. The system of claim 11, wherein the processor is to further adjust brightness of the display using the determined ambient light.

13. The system of claim 12, wherein the processor is to determine the ambient light by determining shutter speed frequency using the shutter speed and determining a logarithm of the gain or the aperture.

14. A tangible medium storing machine-accessible, wherein the data, when accessed, results in a machine performing a method comprising:
getting shutter speed and gain or aperture automatically set by a camera coupled to a display; and
adjusting brightness of the display using the shutter speed and one of the gain and the aperture.

15. The medium of claim 14, wherein adjusting the brightness of the display comprises determining ambient light using the shutter speed and one of the gain and the aperture.

16. The medium of claim 15, wherein determining the ambient light using one of the gain and the aperture comprises taking a logarithm of the gain or the aperture.

17. The medium of claim 16, wherein determining the ambient light using the shutter speed comprises determining a ratio of one over the shutter speed.

18. A method, comprising:
getting shutter speed and aperture from an image capturing device configurable to automatically set the shutter speed and opening of the aperture;
determining shutter speed frequency using the shutter speed;
determining logarithm of the aperture;
determining ambient light using the shutter speed frequency and the logarithm of the aperture; and
adjusting brightness of a display coupled to the image capturing device based on the determined ambient light.

19. The method of claim 18, wherein determining the ambient light comprises applying a scaling factor to the shutter speed frequency.

20. The method of claim 19, wherein the image capturing device is a digital camera, and wherein the aperture is variable.
